(19) United States
(12) Patent Application Publication
(10) Pub. No.: US 2016/0006824 A1
(43) Pub. Date: Jan. 7, 2016

(54) CONNECTION ANNOTATION

(71) Applicants: Ping Wu, Saratoga, CA (US); Jennifer W. Lin, San Jose, CA (US)

(72) Inventors: Ping Wu, Saratoga, CA (US); Jennifer W. Lin, San Jose, CA (US)

(21) Appl. No.: 13/644,153

(22) Filed: Oct. 3, 2012

(51) Int. Cl. H04L 29/08

(52) U.S. Cl. CPC H04L 67/22; H04L 67/306

(57) ABSTRACT

A method, computer program product, and system for connection annotation is described. A method may comprise receiving a first indication that a first user attended an event and a second indication that a second user attended the event. The method may further comprise determining whether a first user account associated with the first user and a second user account associated with the second user are connected via an electronic service. The method may also comprise facilitating connection of the first user account and the second user account via the electronic service. The method may additionally comprise generating an annotation corresponding to the connection between the first user account and the second user account based upon, at least in part, the first indication that the first user attended the event and the second indication that the second user attended the event.

### BACKGROUND

One or more users may attend an event and may meet each other at the event. The one or more users may use an electronic service such as, for example, a social network. Further, the one or more users may or not be connected via the electronic service. Additionally, the one or more users may not remember that they met each other at the event.

### BRIEF SUMMARY

In an implementation, a method may include receiving a first indication that a first user attended an event and a second indication that a second user attended the event. The method may further include determining whether a first user account associated with the first user and a second user account associated with the second user are connected via an electronic service. The method also include, in response to determining that the first user account and the second user account are not connected, facilitating connection of the first user account and the second user account via the electronic service. The method may additionally include generating an annotation corresponding to the connection between the first user account and the second user account based upon, at least in part, the first indication that the first user attended the event and the second indication that the second user attended the event, wherein the annotation indicates that the first user and the second user attended the event.

One or more of the following features may be included. The method may include creating an electronic service connection group for the event, wherein the electronic service connection group includes at least the first user account and the second user account. Facilitating connection of the first user account and the second user account via the electronic service may include checking the first user account into the event via the electronic service connection group based upon, at least in part, receiving the first indication that the first user attended the event. Facilitating connection of the first user account and the second user account via the electronic service may also include checking the second user account into the event via the electronic service connection group based upon, at least in part, receiving the second indication that the second user attended the event. Facilitating connection of the first user account and the second user account via the electronic service may further include adding the second user account to an electronic service connection candidate list for the first user account based upon, at least in part, the first indication that the first user attended the event and the second indication that the second user attended the event, wherein the electronic service connection candidate list indicates that the second user attended the event. Facilitating connection of the first user account and the second user account via the electronic service may additionally include sending an invitation to the second user account, wherein the invitation indicates to the second user that the first user is interested in connection of the first user account and the second user account, wherein the invitation is sent based upon, at least in part, receiving the first indication and the second indication.

In an implementation, the annotation may indicate that the first user and the second user met at the event. The annotation may be generated without the first user or the second user indicating that the annotation is to be generated after the event begins. The annotation may include, at least in part, a tag indicating at least one of: the event, a location associated with the event, a time associated with the event, and one or more users that at least one of the first user and the second user met at the event. The annotation may allow at least one of the first user and the second user to search one or more connected user accounts to determine where one or more users associated with the connected user accounts were met. The annotation may allow at least one of the first user and the second user to search one or more connected user accounts to determine which of the one or more users associated with the connected user accounts were met at the event. Receiving the first indication that the first user attended the event may include receiving a check-in signal from a device associated with the first user. Receiving the first indication that the first user attended the event may include receiving a location signal from a device associated with the first user. The location signal may be, at least in part, received from a positioning device. The location signal may be based upon, at least in part, a calendar entry.

In an implementation, a computer program product may reside on a computer readable storage medium and may have a plurality of instructions stored on it. When executed by a processor, the instructions may cause the processor to perform operations including receiving, via one or more computing devices, a first indication that a first user attended an event and a second indication that a second user attended the event. The operations may further include determining, via the one or more computing devices, whether a first user account associated with the first user and a second user account associated with the second user are connected via an electronic service. The operations may also include, in response to determining that the first user account and the second user account are not connected, facilitating, via the one or more computing devices, connection of the first user account and the second user account via the electronic service. The operations may additionally include generating, via the one or more computing devices, an annotation corresponding to the connection between the first user account and the second user account based upon, at least in part, the first indication that the first user attended the event and the second indication that the second user attended the event, wherein the annotation indicates that the first user and the second user attended the event.

One or more of the following features may be included. The operations may include creating an electronic service connection group for the event, wherein the electronic service connection group includes at least the first user account and the second user account. Facilitating connection of the first user account and the second user account via the electronic service may include checking the first user account into the event via the electronic service connection group based upon, at least in part, receiving the first indication that the first user attended the event. Facilitating connection of the first user account and the second user account via the electronic service may also include checking the second user account into the event via the electronic service connection group based upon, at least in part, receiving the second indication that the second user attended the event. Facilitating connection of the first user account and the second user account via the electronic service may further include adding the second user account to an electronic service connection candidate list for the first user account based upon, at least in part, the first indication that the first user attended the event and the second indication that the second user attended the event, wherein the electronic service connection candidate list indicates that the second user attended the event. Facilitating connection of the first user account and the second user account via the electronic service may additionally include sending an invitation to the second user account, wherein the invitation indicates to the second user that the first user is interested in connection of the first user account and the second user account, wherein the invitation is sent based upon, at least in part, receiving the first indication and the second indication.

In an implementation, a computing system may include one or more processors. The one or more processors may be configured to receive, via one or more computing devices, a first indication that a first user attended an event and a second indication that a second user attended the event. The one or more processors may be further configured to receive, at the one or more computing devices, the consumer-to-business interaction content from a participant computing device of the one or more participant computing devices. The one or more processors may be further configured to determine, via the one or more computing devices, whether a first user account associated with the first user and a second user account associated with the second user are connected via an electronic service. The one or more processors may additionally be configured to, in response to determining that the first user account and the second user account are not connected, facilitate, via the one or more computing devices, connection of the first user account and the second user account via the electronic service. Further, the one or more processors may be configured to generate, via the one or more computing devices, an annotation corresponding to the connection between the first user account and the second user account based upon, at least in part, the first indication that the first user attended the event and the second indication that the second user attended the event, wherein the annotation indicates that the first user and the second user attended the event.

One or more of the following features may be included. The one or more processors may be further configured to create an electronic service connection group for the event, wherein the electronic service connection group includes at least the first user account and the second user account. Facilitating connection of the first user account and the second user account via the electronic service may include checking the first user account into the event via the electronic service connection group based upon, at least in part, receiving the first indication that the first user attended the event. Facilitating connection of the first user account and the second user account via the electronic service may also include checking the second user account into the event via the electronic service connection group based upon, at least in part, receiving the second indication that the second user attended the event. Facilitating connection of the first user account and the second user account via the electronic service may further include adding the second user account to an electronic service connection candidate list for the first user account based upon, at least in part, the first indication that the first user attended the event and the second indication that the second user attended the event, wherein the electronic service connection candidate list indicates that the second user attended the event. Facilitating connection of the first user account and the second user account via the electronic service may additionally include sending an invitation to the second user account, wherein the invitation indicates to the second user that the first user is interested in connection of the first user account and the second user account, wherein the invitation is sent based upon, at least in part, receiving the first indication and the second indication.

In an implementation, a method may include receiving, via one or more computing devices, a first indication that a first user attended an event and a second indication that a second user attended the event. The method may further include determining, via the one or more computing devices, whether a first user account associated with the first user and a second user account associated with the second user are connected via an electronic service. The method may also include, in response to determining that the first user account and the second user account are connected, generating, via the one or more computing devices, an annotation corresponding to the connection between the first user account and the second user account based upon, at least in part, the first indication that the first user attended the event and the second indication that the second user attended the event, wherein the annotation indicates that the first user and the second user attended the event.

These and other implementations may, in some instances and/or situations, provide a user with insight as to the origin of online relationships. For example, the insight into the origin or nature of an online relationship may be reflected in the user's online connections. In some implementations, the insight may provide context regarding the nature of a connection or online relationship, such as an indicator of when and/or where individuals first met and/or an indication of an event, or events, that resulted in the connection. In some implementations, the making of connections between individuals who met at an event may be facilitated.

The details of one or more implementations are set forth in the accompanying drawings and the description below. Other features and advantages will become apparent from the description, the drawings, and the claims.

### BRIEF DESCRIPTION OF THE DRAWINGS

FIG. 1 depicts an example system that can execute implementations of the present disclosure;

FIG. 2 is a flowchart illustrating an example process for connection annotation in accordance with the present disclosure;

FIG. 3 depicts an example graphical user interface of an implementation of the present disclosure; and

FIG. 4 is a flowchart illustrating an example process for connection annotation in accordance with the present disclosure.

### DETAILED DESCRIPTION

One or more users may attend an event and may be connected with other attendees of the event in the real world or electronically (e.g., via online connections). Some of these connections (e.g., online relationships) may provide the users involved with little or no context regarding the nature of the relationship, such as how, when or where the relationship was formed. For example, User A and User B may have an electronic connection (e.g., online) that resulted from User A and User B attending the same event. User A may wish to remember where or when he/she first met User B. However, the online connection may provide little or no context for User A to determine where or when he/she first met User B.

An electronic service such as social networking application supporting connections or online relationships may facilitate User A and User B in forming the connection that resulted from User A and User B attending the same event. Further, in some implementations, an annotation for the connection between User A and User B may be automatically generated by, e.g., the electronic service. The annotation may indicate that User A and User B attended the same event and/or first met at the event.

For example, the electronic service (e.g., social network) may determine that User A and User B met at the event by using information that may be obtained, e.g., from location-based services (e.g., which may be provided by computing devices associated with User A and User B) or check-in features (e.g., which may be associated with a webpage or website associated with the event, and/or a calendar/scheduling application associated with one or both of User A and User B). The electronic service may facilitate User A and User B in forming the connection (e.g., online relationship) and may automatically annotate the connection such that it indicates User A and User B first met at the event. User A or User B may later search their electronic service (e.g., social network) to see who they met at the event, or may refer to the annotation to remember where they first met each other. In this way, the electronic service may automatically annotate connections such that they provide context about the connections for the users involved.

It should be noted that one or more users of the electronic service may not wish to have the electronic service determine information about their connections. Therefore, in such an implementation, in order to have the electronic service determine information, these users may selectively utilize a feature allowing the electronic service to determine the information about their connections. Further, in an example implementation, these users may selectively choose to not use the feature allowing the electronic service to determine the information about their connections, and may not have the electronic service determine such information.

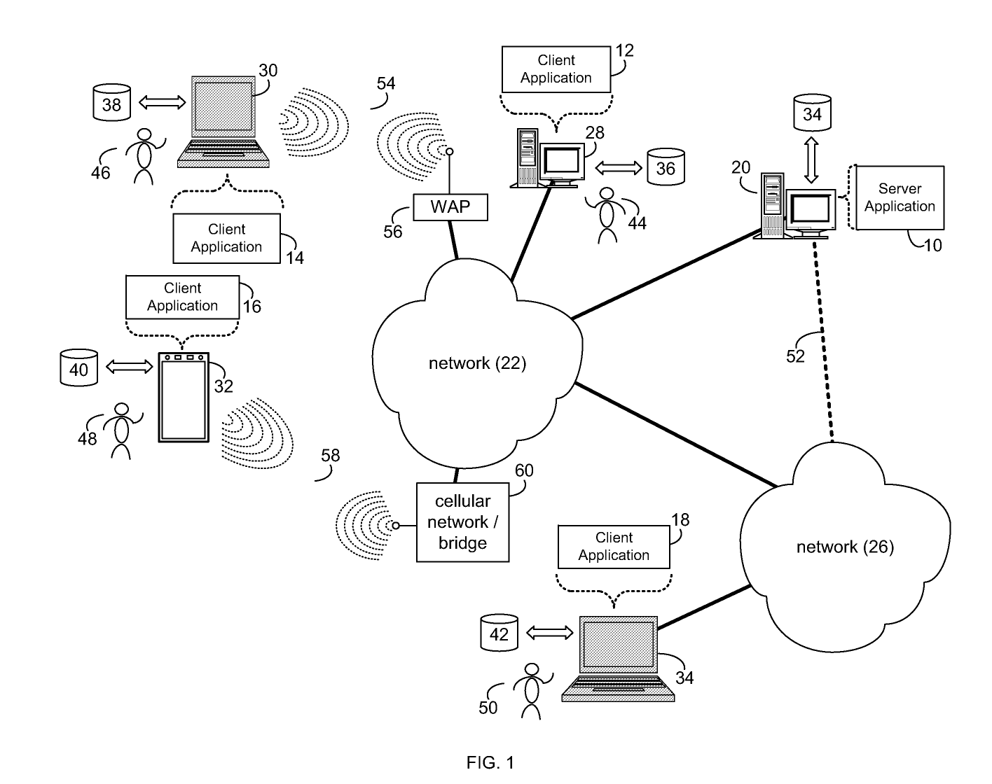

Referring to FIGS. 1 & 2, there is shown a server application 10 and client applications 12, 14, 16, and 18. Server application 10 and/or one or more of client applications 12, 14, 16, and/or 18 may execute one or more processes configured to carry out one or more of the features described herein. Server application 10 may be referred to as a process configured to carry out one or more of the features described herein, such as connection annotation process 10. Further, one or more of client applications 12, 14, 16, and 18 may be referred to as a process configured to carry out one or more of the features described herein, such as connection annotation processes 12, 14, 16, and/or 18.

As will be discussed below, connection annotation process 10 may receive 100 a first indication that a first user attended an event and a second indication that a second user attended the event. Connection annotation process 10 may also determine 102 whether a first user account associated with the first user and a second user account associated with the second user are connected via an electronic service. Connection annotation process 10 may further, in response to determining that the first user account and the second user account are not connected, facilitate 104 connection of the first user account and the second user account via the electronic service. Connection annotation process 10 may additionally generate 106 an annotation corresponding to the connection between the first user account and the second user account based upon, at least in part, the first indication that the first user attended the event and the second indication that the second user attended the event, wherein the annotation indicates that the first user and the second user attended the event.

The connection annotation (CA) process may be a server-side process (e.g., server-side CA process 10), a client-side process (e.g., client-side CA process 12, client-side CA process 14, client-side CA process 16, or client-side CA process 18), or a hybrid server-side/client-side process (e.g., a combination of server-side CA process 10 and one or more of client-side CA processes 12, 14, 16, 18).

Referring to FIG. 1, server-side CA process 10 may reside on and may be executed by server computer 20, which may be in communication with network 22 (e.g., the Internet or a local area network). Examples of server computer 20 may include, but are not limited to: a personal computer, a server computer, a series of server computers, a mini computer, and/or a mainframe computer. The server computer 20 may be a distributed system and the operations of server computer 20 may execute on one or more processors, simultaneously and/or serially. Server computer 20 may execute one or more operating systems, examples of which may include but are not limited to: Microsoft Windows Server™; Novell Netware™; Redhat Linux™, Unix, or a custom operating system, for example.

The instruction sets and subroutines of server-side CA process 10, which may be stored on storage device 34 coupled to server computer 20, may be executed by one or more processors (not shown) and one or more memory architectures (not shown) incorporated into server computer 20. Storage device 34 may include but is not limited to: a hard disk drive; a tape drive; an optical drive; a RAID array; a random access memory (RAM); and a read-only memory (ROM).

Server computer 20 may execute a web server application that allows for access to server computer 20 (via network 22) using one or more protocols, examples of which may include but are not limited to HTTP (i.e., HyperText Transfer Protocol). Network 22 may be in communication with one or more secondary networks (e.g., network 26), examples of which may include but are not limited to: a local area network; a wide area network; or an intranet, for example.

Client-side CA processes 12, 14, 16, 18 may reside on and may be executed by client electronic devices 28, 30, 32, and/or 34 (respectively), examples of which may include but are not limited to personal computer 28, a television with one or more processors embedded therein or coupled thereto (not shown), laptop computer 30, data-enabled mobile telephone 32, notebook computer 34, a tablet (not shown), and a personal digital assistant (not shown), for example. Client electronic devices 28, 30, 32, and/or 34 may each be in communication with network 22 and/or network 26 and may each execute an operating system, examples of which may include but are not limited to Apple iOS™, Microsoft Windows™, Android™, Redhat Linux™, or a custom operating system.

The instruction sets and subroutines of client-side CA processes 12, 14, 16, 18, which may be stored on storage devices 36, 38, 40, 42 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Storage devices 36, 38, 40, 42 may include but are not limited to: hard disk drives; tape drives; optical drives; RAID arrays; random access memories (RAM); read-only memories (ROM); compact flash (CF) storage devices; secure digital (SD) storage devices; and memory stick storage devices.

Client-side CA processes 12, 14, 16, 18 and/or server-side CA process 10 may be processes that run within (i.e., ma be part of) an application (e.g., a social networking application). Alternatively, client-side CA processes 12, 14, 16, 18 and/or server-side CA process 10 may be stand-alone applications that may work in conjunction with the application (e.g., a social networking application). One or more of client-side CA processes 12, 14, 16, 18 and server-side CA process 10 may interface with each other (via network 22 and/or network 26).

Users 44, 46, 48, 50 may access server-side CA process 10 directly through the device on which the client-side CA process (e.g., client-side CA processes 12, 14, 16, 18) is executed, namely client electronic devices 28, 30, 32, 34, for example. Users 44, 46, 48, 50 may access server-side CA process 10 directly through network 22 and/or through secondary network 26. Further, server computer 20 (i.e., the computer that executes server-side CA process 10) may be in communication with network 22 through secondary network 26, as illustrated with phantom link line 52.

The various client electronic devices may be directly or indirectly coupled to network 22 (or network 26). For example, personal computer 28 is shown directly coupled to network 22 via a hardwired network connection. Further, notebook computer 34 is shown directly coupled to network 26 via a hardwired network connection. Laptop computer 30 is shown wirelessly coupled to network 22 via wireless communication channel 54 established between laptop computer 30 and wireless access point (i.e., WAP) 56, which is shown directly coupled to network 22. WAP 56 may be, for example, an IEEE 802.11a, 802.11b, 802.11g, 802.11n, Wi-Fi, and/or Bluetooth device that is capable of establishing a wireless communication channel 54 between laptop computer 30 and WAP 56. Data-enabled mobile telephone 32 is shown wirelessly coupled to network 22 via wireless communication channel 58 established between data-enabled mobile telephone 32 and cellular network/bridge 60, which is shown directly coupled to network 22.

All of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth is a telecommunications industry specification that allows e.g., mobile phones, computers, and personal digital assistants to be interconnected using a short-range wireless connection.

For the following discussion, server-side CA process 10 will be described for illustrative purposes. It should be noted that server-side CA process 10 may interact with client-side CA process 12 and may be executed within one or more applications that allow for communication with client-side CA process 12. However, this is not intended to be a limitation of this disclosure, as other configurations are possible (e.g., stand-alone, client-side CA processes and/or stand-alone server-side CA processes). For example, some implementations may include one or more of client-side CA processes 12, 14, 16, 18 in place of or in addition to server-side CA process 10.

Referring now to FIGS. 1-3, user 48 may be a user of an electronic service. The electronic service may be, for example, social network 302, which may be associated with a social networking application. While social network 302 may be described herein as an electronic service with which one or more techniques or features of the present disclosure may be utilized, the electronic service may also be any type of application which allows one or more users to form connections or online relationships. Further, the electronic service may be any application through which one user may be connected to another, may be electronic friends with a another, may follow another, or may be professionally associated with another. The electronic service may be any application through which connected users can share content with each other.

For example, social network 302 may include one or more users (e.g., users 44, 46, 48 and 50). One or more of users 44, 46, and 50 may be a friend or connection of user 48 on social network 302. Further, user 48 may be a member of a social circle of which one or more of users 44, 46, and 50 are also members.

User 48 may interact with social network 302 via graphical user interface (GUI 300). For example user 48 may access social network account 304 via GUI 300. Social network account 304 may be user 48's account on a social networking application. Graphical user interface 300 may be available from the social networking application through which social network 302 and social network account 304 may be maintained and/or accessed. In order to access social network account 304, user 48 and/or a computing device (e.g., client electronic device 32) associated with user 48 may need to be authenticated by the social networking application (e.g., via a username and/or password).

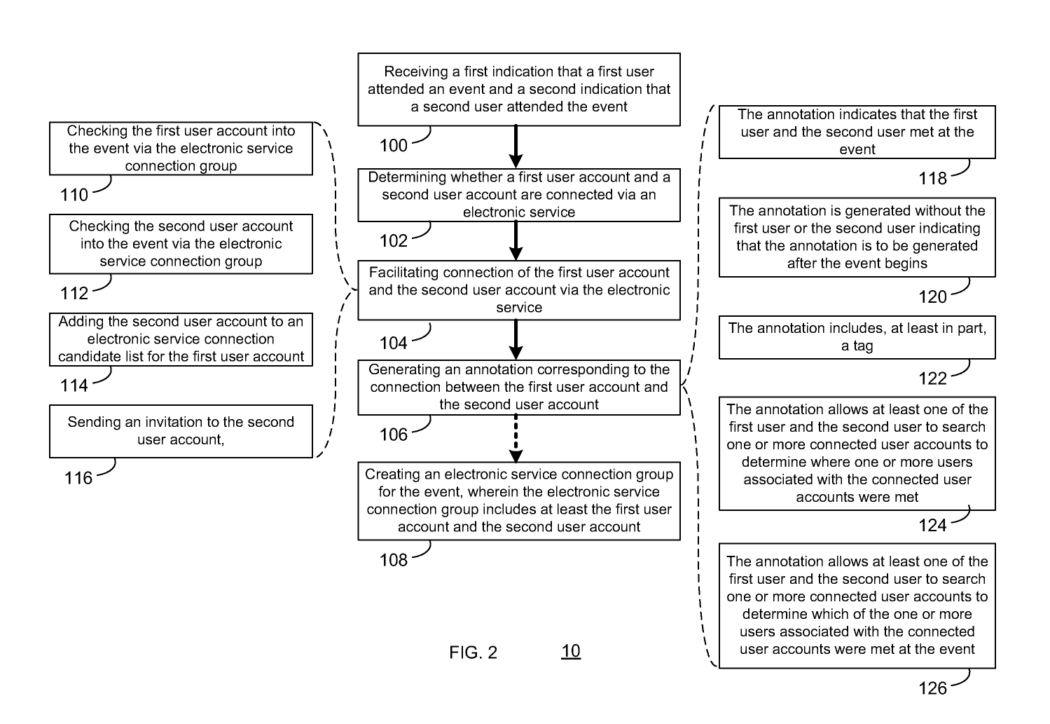

As shown in FIG. 2, according to an implementation, CA process 10 may receive 100 a first indication that a first user attended an event and a second indication that a second user attended the event. CA process 10 may also determine 102 whether a first user account associated with the first user and a second user account associated with the second user are connected via an electronic service. In response to determining that the first user account and the second user account are not connected, CA process 10 facilitate 104 connection of the first user account and the second user account via the electronic service. CA process 10 may further generate 106 an annotation corresponding to the connection between the first user account and the second user account based upon, at least in part, the first indication that the first user attended the event and the second indication that the second user attended the event. The annotation may indicate that the first user and the second user attended the event.

For example, in an illustrative implementation, CA process 10 may receive 100 a first indication that a first user (e.g. user 48) attended an event. CA process 10 may also receive 100 a second indication that a second user (e.g., user 44) also attended the event. Accordingly, CA process 10 may receive 100 indications that both user 48 and user 44 attended the same event. In various implementations, events may include any physical or virtual gathering or intersection of individuals having one or more of a defined location (e.g., a defined physical location and/or a defined online location or space), a defined time, or a defined participant set. Examples of events may include, but are not limited to, social events, such as parties, concerts, or other gatherings; professional events, such as conferences, workshops, classes, networking events, conference calls, web conferences, and the like. It will be appreciated that events, as described herein may include any other situation involving more than one individual and including a specific location(s), a specific time, and/or specific participants. Further, it will be appreciated that events, as described herein, may include virtual events involving more than one individual connecting via virtual space (such as a web conference, an online multi-party meeting discussion, game, etc.) that may provide for interaction among the attendees, and which may include one or more of a specific time and/or specific participants.

In an implementation, receiving 100 the first indication that the first user attended the event may include receiving a check-in signal from a device associated with the first user. For example, the event may have a website, webpage, or other system that may allow participants in the event to indicate that they have arrived at the location, and/or are otherwise currently participating in the event. In an implementation, the first user (e.g., user 48) may access a check-in system associated with the event via a device associated with user 48 (e.g., data-enabled mobile telephone 32). In an implementation, user 48 may access the check-in system via graphical user interface 300 associated with social network 302. For example, user 48 may access an event page via user account 304. The event page may include a page associated with the event that user 48 is attending. In an implementation, the event page may allow user 48 to check-into the event, thereby providing an affirmative indication that user 48 is at the event. In an implementation, checking-in may result in CA process 10 receiving 100 the first indication that the first user (e.g., user 48) attended the event). As, such, receiving the check-in signal may include receiving an affirmative indication from the first user that the first user attended the event. For example, user 48 may be logged into social network 302, thereby allowing the check-in system to ascertain an identity of user 48. Various additional/alternative mechanisms may be utilized to ascertain the identity of the first user. As generally described in an implementation, the check-in system may be maintained via, and/or in communication with, the electronic service (e.g., social network 302). In a similar manner as described above, receiving 100 the second indication that the second user attended the event may include receiving a check-in signal from a device associated with the second user.

In an example implementation, receiving 100 the first indication that the first user attended the event may include receiving a location signal from a device associated with the first user. For example, as generally discussed above, the event may include a specified location. In an implementation, the event may also include a specified time. In such an implementation, the first user's presence at the specified location of the event at the specified time of the event may be indicative of the first user's attendance at the event. As is generally known, many mobile computing devices, such as smartphones, tablet computers, and the like, may provide location functionality (e.g., global positioning systems, cellular tower triangulation, etc.) by which at least a general location of the mobile computing device may be determined. In such an implementation, the mobile computing device (e.g., data-enabled mobile telephone 32 associated with user 48) may provide functionality as a positioning device. In an implementation, CA system 10 may receive 100 the first indication that the first user attended the event, including receiving a location signal (e.g., from data-enabled mobile telephone 32, which may operate as a positioning device, in some implementations) that may indicate that user 48 is at the specified location of the event at the specified time of the event. In some implementations, CA process 10 may similarly receive 100 a second indication that the second user attended the event based on, at least in part, receiving a location signal from a device associated with the second user.

In an implementation, the location signal may be based upon, at least in part, a calendar entry. For example, as generally discussed above, an event may include a specified time and/or a specified location. In an implementation, the specified time and/or the specified location associated with the event may be included within a calendar entry (e.g., which may be maintained by a calendaring/scheduling system, the electronic service, and/or another system, service, or application which may interface with and/or be accessible by the electronic service). In an implementation in which the calendar entry may include one or more of the location and the time associated with the event, the correspondence between the time and/or location of the event and the location signal received from a device associated with the first user may indicate that the first user attended the event. It will be appreciated that receiving the second indication may similarly be based on, at least in part, a location signal from a device associated with the second user.

Consistent with the foregoing the first indication and/or the second indication may be based on a variety of signals and/or information received by CA process 10. For example, the first indication and/or the second indication may be based on, at least in part, an affirmative indication by a user of attendance at the event (e.g., a check-in by the user), and/or geo-sensing (e.g., location data received by a device associated with the user). In an implementation, the first indication and/or the second indication may be based on, at least in part, an indication by a third party. For example, the first user may not be a formally invited participant of the event but may be invited by an invited participant of the event (e.g. a third user), and/or otherwise be present at the location of the event at the time during which the event is taking place. In an implementation, an invited participant of the event (e.g., the third user) may provide an indication of the presence of the user at the event, e.g., by tagging the first user as being present at the event (e.g., tagging the a user account of the first user as being present at the event via the electronic service). In one such example, the first user may be included in a photo of the event (e.g., which may be tagged as being a photo of the event and/or uploaded to a webpage associated with the event). The first user may be tagged in the photo (e.g., a user of the electronic service may tag the photo as including the first user). Based on, at least in part, the photo being associated with the event (e.g. as by being tagged with the event), and based on, at least in part, the first user being indicated as being in the photo (e.g., and therefore as being present at the event), the first indication 100 may be received indicating the first user attended the event.

CA process 10 may determine 102 whether a first user account associated with the first user and a second user account associated with the second user are connected via an electronic service. For example, the electronic service (e.g., social network 302) may allow connections between users to be established. CA process 10 may determine whether such a connection (e.g., which may indicate an associate or prior interaction) has been established between the first user and the second user (e.g., based on a connection being established between a user account associated with the first user and a user account associated with the second user) via the electronic service.

In an implementation, CA process 10 may determined that there is not a connection between the first user and the second user within the electronic service (e.g., based on an absence of an indicated connection between the first user account associated with the first user and the second user account associated with the second user). The absence of the connection between the first user account and the second user account within the electronic service may suggest that the first user and the second user did not know each other and/or had not formed a relationship with one another prior to the event. In other implementations, the absence of the connection within the electronic service may suggest that the first user and the second user have not memorialized their relationship via the electronic service. In an implementation, in response to determining that the first user account and the second user account are not connected, CA process 10 may facilitate 104 connection of the first user account and the second user account via the electronic service.

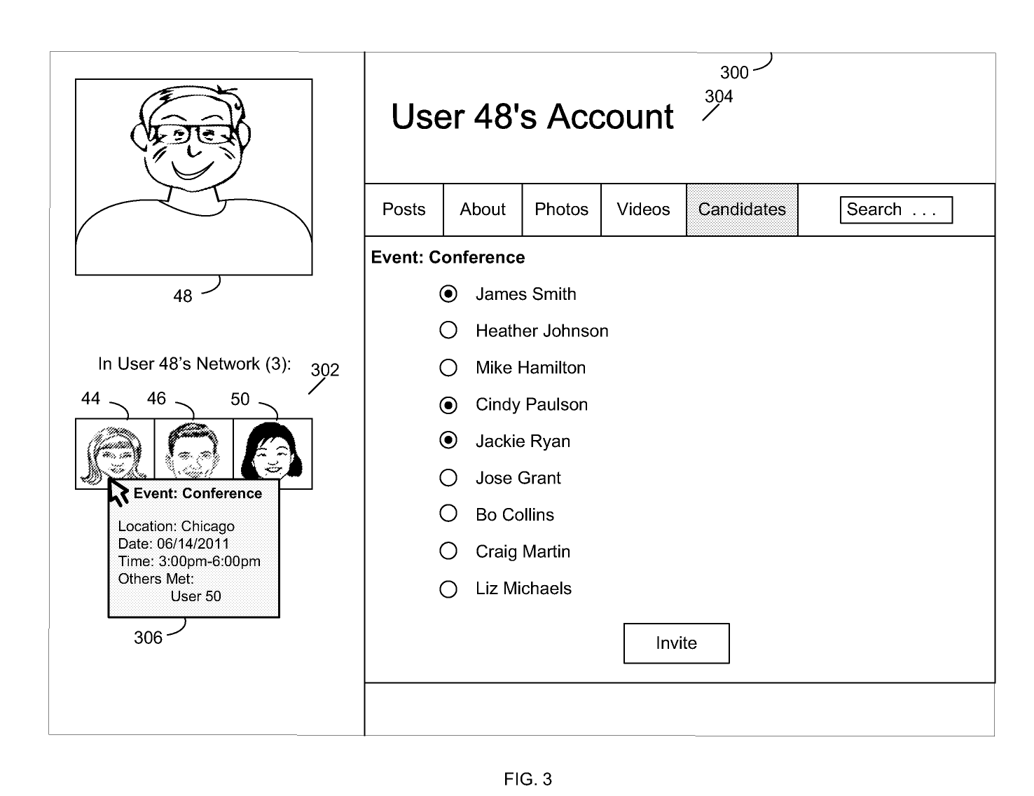

In an implementation, facilitating 104 connection of the first user account and the second user account via the electronic service may further include adding 114 the second user account to an electronic service connection candidate list for the first user account. Addition 114 the second user account to an electronic service connection candidate list for the first user account may be based upon, at least in part, the first indication that the first user attended the event and the second indication that the second user attended the event. The electronic service connection candidate list may indicate that the second user attended the event. For example, as shown in FIG. 3, the electronic service connection candidate list may include a list of user accounts (e.g., each of which may be associated with a respective user) with whom the first user may be interested in making a connection via the electronic service. In an implementation, CA process 10 may add 114 the second user to an electronic service connection candidate list for the first user based on the common attendance of both the first user and the second user at the event (e.g., as may be indicated by the respective first indication and second indication). That is, as both the first user and the second user attended the event, it may be possible that first user and the second user may have met at the event. As such, CA process 10 may add 114 the second user account to the electronic service connection candidate list associated with the first user. thereby indicating to the first user that the second user may include an individual with whom the first user may have interacted, and that the second user may therefore be an individual with whom the first user may wish to form a connection via the electronic service. Addition the second user to an electronic service connection candidate list associated with the first user may, for example, refresh the first user's recollection of individuals that the first user met at the event. As such, if the first user had forgotten the second user's name, or was uncertain as to the exact spelling of the second user's name, the electronic service connection candidate list may refresh the first user's recollection, and facilitate the first user forming a connection with the second user.

In an implementation, facilitating 104 connection of the first user account and the second user account via the electronic service may include sending 116 an invitation to the second user account. In an implementation, the invitation may include an electronic message (e.g., which may be automatically generated by the electronic service, manually generated by the first user, and/or partially manually generated by the first user and partially automatically generated by the electronic service) that may be transmitted to the second user account. Transmitting the invitation to the second user account may all the invitation to be received by the second user (e.g., via a user interface associated with the second user account). The invitation may indicate to the second user that the first user is interested in connection of the first user account and the second user account. For example, the invitation may indicate that the first user and the second user did, or may have, met or interacted at the event. The invitation may also indicate that the first user wishes to connect with the second user via the electronic service. Further, the invitation may be sent based upon, at least in part, receiving the first indication and the second indication. For example, and as generally discussed above, receiving 100 the first indication and the second indication may be indicative of the first user and the second user both attending the event, and therefore, may be indicative of the first user and the second user having met or interacted at the event. Accordingly, sending 116 the invitation may be based on, at least in part, the first indication and the second indication, e.g., which may suggest that the first user and the second user attended the same event.

CA process 10 may generate 106 an annotation corresponding to the connection between the first user account and the second user account based upon, at least in part, the first indication that the first user attended the event and the second indication that the second user attended the event. The annotation generated 106 by CA process 10 may indicate that the first user and the second user attended the event. In such an implementation, the annotation may provide context to the relationship between the first user and the second user. For example, the annotation may indicate 118 that the first user and the second user met at (or at least both attended) the event. As such, the annotation may provide richer data surrounding the relationship between the first user and the second user (which may be indicated by the connection of the first user account and the second user account via the electronic service).

In an implementation, the annotation may be generated 120 without the first user or the second user indicating that the annotation is to be generated after the event begins. That is, in an implementation, CA process 10 may automatically generate 106 the annotation without requiring an instruction or request by either of the first user or the second user. For example, in an implementation, a connection may be established between the first user account and the second user account via the electronic service. In response to the connection between the first user account and the second user account via the electronic service, CA process 10 may determine that both the first user and the second user attended the event. Based on, at least in part, the determination that both the first user and the second user attended the event, CA process 10 may generate 106 the annotation indicating that both the first user and the second user attended the event. The annotation may, in an implementation, be associated with one or more of the first user account and the second user account. The annotation may be generated 120 without the first user or the second user indicating that the annotation is to be generated after the event begins.

In an implementation, the annotation may include 124, at least in part, a tag indicating at least one of: the event, a location associated with the event, a time associated with the event, and one or more users that at least one of the first user and the second user met at the event. For, example, the tag may include metadata that may be associated with the connection between the first user account and the second user account. The tag may include contextual information about the connection between the first user account and the second user account. In an implementation, the tag may indicate that the first user and the second user met at the event, e.g., which may provide context to the relationship indicated by the connection between the first user account and the second user account. In an implementation, the tag may also provide contextual information regarding the event. For example, the tag may include an identifier of the event (for example, that the event was a data mining conference in Chicago on Jun. 14, 2011, between 3 PM and 6 PM). In an implementation, the tag may indicate other individuals that were also met at the event (e.g., with whom connections may also have been made via the electronic service, and/or individuals having user accounts with the electronic service, but with whom a connection has not been made). In various such implementations, the relationship (e.g., which may be indicated by the connection between the first user account and the second user account via the electronic service) may be tagged with the event, and may provide rich data of contextual information about the relationship.

In an implementation, the annotation may allow 124 at least one of the first user and the second user to search one or more connected user accounts to determine where one or more users associated with the connected user accounts were met. For example, as shown in FIG. 3, user account graphical user interface 300 associated with social network account of user 48 may include an indication of users who are within user 48's network (e.g., user 44, user 46, and user 50, in the illustrated example). For example, in an implementation, user 48 may select one of the users within user 48's network. In response to user 48 selecting a user (e.g., user 44 in the illustrated example), CA process 10 may search the connected user account (e.g., user 44's account) to determine where user 48 and user 44 met. For example, searching user 44's account may identify the second indication, which may indicate that user 44 attended the conference in Chicago on Jun. 14, 2011, prior to the connection with user 48 being established via the electronic service. Based on, at least in part, the first indication that user 48 attended the conference in Chicago on Jun. 14, 2011 and the second indication that user 44 also attended the conference, CA process 10 may determine that user 48 and user 44 met at the conference in Chicago on Jun. 14, 2011. The search results may, for example, be displayed in pop-up 306.

In an implementation, the annotation may allow 126 at least one of the first user and the second user to search one or more connected user accounts to determine which of the one or more users associated with the connected user accounts were met at the event. For example, and continuing with the previous example, in addition to searching a user account associated with user 44 (e.g., to determine that user 48 and user 44 met at the conference in Chicago on Jun. 14, 2011), CA process 10 may also search other connections associated with the first user account to determine if any of the connections are also tagged with the conference in Chicago on Jun. 14, 2011. For example, as shown in pop-up 306, CA process 10 may also identify that user 48 met user 50 at the conference. While the foregoing examples have utilized an implementation in which CA process 10 may allow user accounts to be searched 124, 126 and may display results via pop-up 306, it will be appreciated that various additional/alternative search user interfaces may be equally utilized.

In an implementation, CA process 10 may create 108 an electronic service connection group for the event. In an implementation, the electronic service connection group includes at least the first user account and the second user account. CA process 10 may determine all user accounts indicated as attending the event (e.g., based on check-in information, location information, or the like, as generally described above). In an implementation, CA process 10 may create 108 an electronic service connection group that may include an indicator or listing of all of the participant of the event. The electronic service connection group for the event may allow users who participated in the even to see who the other participants of the event were. In some implementations, the electronic service connection group for the event may also allow the participants of the event (e.g., who also have user accounts via the electronic service) to communicate with one another (e.g., via messaging service provided by the electronic service), and/or otherwise interact with one another. In some implementations, the electronic service connection group may provide a page or account within the electronic service (e.g., which may include social network 302) that may include information and/or content (e.g., electronic pictures, multimedia content, etc.) regarding the event. The page or account for the connection group may be accessible by at least a portion of the participants of the event.

In an implementation, facilitating 104 connection of the first user account and the second user account via the electronic service may include checking 110 the first user account into the event via the electronic service connection group based upon, at least in part, receiving the first indication that the first user attended the event. For example, based on, at least in part, receiving 100 the first indication, CA process 10 may check the first user account into 110 the event in the electronic service connection group created 108 via the electronic service. Checking the first user account into 110 the event on the electronic service connection group may provide an indicator, within the electronic service connection group, that the first user attended the event. As such, other users having access to the electronic service connection group may be able to determine that the first user attended the event. As such, CA process 10 may facilitate 104 connection of the first user account and other user accounts (e.g., a user account associated with the second user) associated with users who also attended the event (and/or otherwise may have access to the electronic service connection group). In a generally similar manner, facilitating 104 connection of the first user account and the second user account via the electronic service may also include checking 112 the second user account into the event via the electronic service connection group based upon, at least in part, receiving the second indication that the second user attended the event. As such, the second user may also be indicated within the electronic service connection group as having attended the event. As such, connections between user accounts may be facilitated for users who attended the event.

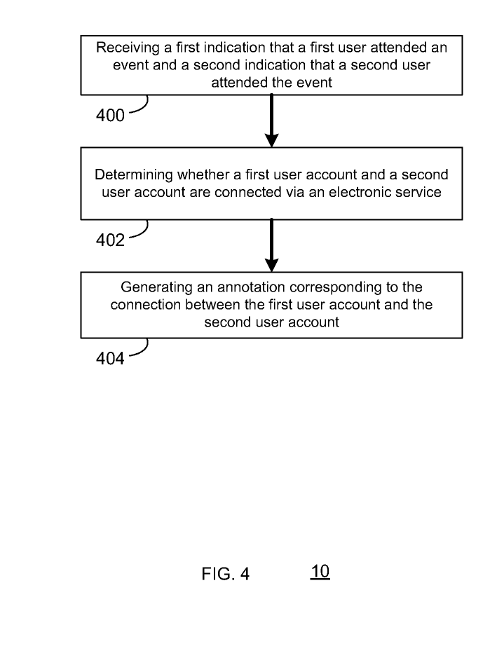

Referring also to FIG. 4, in an implementation CA process 10 may receive 400 a first indication that a first user attended an event and a second indication that a second user attended the event. In general, CA process 10 may receive one or more of the first indication and the second indication in a manner as generally discussed above. For example, CA process 10 may receive a check-in signal indicative of the first user and/or the second user attending the event. In some implementations, geo-sensing functionality associated with a computing device associated with one or more of the first user and the second user may indicate that the first user and/or the second user was physically present at the location and time associated with the event. Various additional/alternative features may be implemented for receiving 400 the first indication and/or the second indication, as have generally been discussed herein above.

In an implementation, CA process 10 may determine 402 whether a first user account and a second user account are connected via an electronic service. In an example implementation, the electronic service may include a social network (e.g. social network 302). CA process 10 may determine 402 whether the first user account and the second user account are connected based on the presence and/or absence of an indicator of a connection associated with one or more of the first user account and the second user account.

In response to determining the connection between the first user account and the second user account, CA process 10 may generate 404 an annotation corresponding to the connection between the first user account and the second user account. For example, CA process 10 may generate 404 the annotation based upon, at least in part, the first indication that the first user attended the event and the second indication that the second user attended the event. The annotation may indicate that the first user and the second user attended the event. According to such an implementation, the annotation may provide a real-world context to the connection between the first user account and the second user account via the electronic service. For example, the annotation may indicate where the first user and the second user met and/or common events that the first user and the second user may have attended.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

Implementations of the present disclosure and all of the functional operations provided herein can be realized in digital electronic circuitry, or in computer software, firmware, or hardware, including the structures disclosed in this specification and their structural equivalents, or in combinations of one or more of them. Implementations of the disclosure can be realized as one or more computer program products, i.e., one or more modules of computer program instructions encoded on a computer readable medium for execution by, or to control the operation of, a data processing apparatus. The computer readable medium can be a machine-readable storage device, a machine readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions or computer program products and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. These may also be referred to as computer readable storage media. The processor and the memory can be supplemented by, or incorporated in, special purpose logic circuitry.

To provide for interaction with a user, implementations of described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations of the present disclosure can be realized in a computing system that includes a back end component, e.g., as a data server, or that includes a middleware component, e.g., an application server, or that includes a front end component, e.g., a client computer having a graphical user interface or a Web browser through which a user can interact with an implementation of the present disclosure, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this disclosure contains many specifics, these should not be construed as limitations on the scope of the disclosure or of what may be claimed, but rather as descriptions of features specific to particular implementations of the disclosure. Certain features that are described in this disclosure in the context of separate implementations can also be provided in combination in a single implementation. Conversely, various features that are described in the context of a single implementation can also be provided in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

A number of implementations and implementations have been described. Nevertheless, it will be understood that various modifications may be made. Accordingly, other implementations and implementations are within the scope of the following claims. For example, the actions recited in the claims can be performed in a different order and still achieve desirable results.

1. A computer-implemented method comprising:
receiving, via one or more computing devices, a first indication that a first user of a social network attended an event and a second indication that a second user of the social network attended the event;
determining, via the one or more computing devices, whether a connection between a first user account associated with the first user and a second user account associated with the second user is existent on the social network prior to the first user and the second user of the social network having attended the event;
responsive to determining that the connection being nonexistent between the first user account and the second user account on the social network prior to the first user and the second user having attended the event, facilitating, via the one or more computing devices, a forming of the connection between the first user account and the second user account on the social network based on the first indication that the first user attended the event and the second indication that the second user attended the event;
generating, via the one or more computing devices, an annotation corresponding to the formed connection between the first user account and the second user account on the social network based upon, at least in part, the first indication that the first user attended the event and the second indication that the second user attended the event, wherein the annotation identifies a context for the formed connection between the first user account and the second user account on the social network, the context identifying an origin of the formed connection by indicating that the first user and the second user first met at the event;
annotating, via the one or more computing devices, the formed connection between the first user account and the second user account with the annotation on the social network;
determining, via the one or more computing devices, the first user searching for the second user on the social network; and
providing for display, via the one or more computing devices, the annotation in association with the second user account associated with the second user responsive to the first user searching for the second user.

2. The computer-implemented method of claim 1, further comprising:
creating a social network connection group for the event, wherein the social network connection group includes at least the first user account and the second user account.

3. The computer-implemented method of claim 2, wherein facilitating the forming of the connection between the first user account and the second user account via the social network comprises:
checking the first user account into the event via the social network connection group based upon, at least in part, receiving the first indication that the first user attended the event; and
checking the second user account into the event via the social network connection group based upon, at least in part, receiving the second indication that the second user attended the event.

4. The computer-implemented method of claim 1, wherein facilitating the forming of the connection between the first user account and the second user account via the social network comprises:
adding the second user account to a social network connection candidate list for the first user account based upon, at least in part, the first indication that the first user attended the event and the second indication that the second user attended the event, wherein the social network connection candidate list indicates that the second user attended the event.

5. The computer-implemented method of claim 1, wherein facilitating the forming of the connection between the first user account and the second user account via the social network comprises:
sending an invitation to the second user account, wherein the invitation indicates to the second user that the first user is interested in connection of the first user account and the second user account, wherein the invitation is sent based upon, at least in part, receiving the first indication and the second indication.

6. The computer-implemented method of claim 1, wherein the annotation indicates that the first user and the second user met at the event.

7. The computer-implemented method of claim 1, wherein the annotation is generated without the first user or the second user indicating that the annotation is to be generated after the event begins.

8. The computer-implemented method of claim 1, wherein the annotation includes, at least in part, a tag indicating at least one of: the event, a location associated with the event, a time associated with the event, and one or more users that at least one of the first user and the second user met at the event.

9. The computer-implemented method of claim 1, wherein the annotation allows at least one of the first user and the second user to search one or more connected user accounts to determine where one or more users associated with the connected user accounts were met.

10. The computer-implemented method of claim 1, wherein the annotation allows at least one of the first user and the second user to search one or more connected user accounts to determine which of the one or more users associated with the connected user accounts were met at the event.

11. The computer-implemented method of claim 1, wherein receiving the first indication that the first user attended the event comprises receiving a check-in signal from a device associated with the first user.

12. The computer-implemented method of claim 1, wherein receiving the first indication that the first user attended the event comprises receiving a location signal from a device associated with the first user.

13. The computer-implemented method of claim 12, wherein the location signal is, at least in part, received from a positioning device.

14. The computer-implemented method of claim 12, wherein the location signal based upon, at least in part, a calendar entry.

15. A computer program product residing on a non-transitory computer readable storage medium having a plurality of instructions stored thereon, which, when executed by a processor, cause the processor to perform operations comprising:
receiving a first indication that a first user of a social network attended an event and a second indication that a second user of the social network attended the event;
determining whether a connection between a first user account associated with the first user and a second user account associated with the second user is existent on the social network prior to the first user and the second user of the social network having attended the event;
responsive to determining that the connection being nonexistent between the first user account and the second user account on the social network prior to the first user and the second user having attended the event, facilitating a forming of the connection between the first user account and the second user account on the social network based on the first indication that the first user attended the event and the second indication that the second user attended the event;
generating an annotation corresponding to the formed connection between the first user account and the second user account on the social network based upon, at least in part, the first indication that the first user attended the event and the second indication that the second user attended the event, wherein the annotation identifies a context for the formed connection between the first user account and the second user account on the social network, the context identifying an origin of the formed connection by indicating that the first user and the second user first met at the event;
annotating the formed connection between the first user account and the second user account with the annotation on the social network;
determining the first user searching for the second user on the social network; and
providing the annotation in association with the second user account associated with the second user responsive to the first user searching for the second user.

16. The computer program product of claim 15, wherein the operations further comprise:
creating a social network connection group for the event, wherein the social network connection group includes at least the first user account and the second user account.

17. The computer program product of claim 16, wherein facilitating the forming of the connection between the first user account and the second user account via the social network comprises:
checking the first user account into the event via the social network connection group based upon, at least in part, receiving the first indication that the first user attended the event; and
checking the second user account into the event via the social network connection group based upon, at least in part, receiving the second indication that the second user attended the event.

18. The computer program product of claim 15, wherein facilitating the forming of the connection between the first user account and the second user account via the social network comprises:
adding the second user account to a social network connection candidate list for the first user account based upon, at least in part, the first indication that the first user attended the event and the second indication that the second user attended the event, wherein the social network connection candidate list indicates that the second user attended the event.

19. The computer program product of claim 15, wherein facilitating the forming of the connection between the first user account and the second user account via the social network comprises:
sending an invitation to the second user account, wherein the invitation indicates to the second user that the first user is interested in connection of the first user account and the second user account, wherein the invitation is sent based upon, at least in part, receiving the first indication and the second indication.

20. A computing system comprising one or more processors, wherein the one or more processors are configured to:
receive a first indication that a first user of a social network attended an event and a second indication that a second user of the social network attended the event;
determine whether a connection between a first user account associated with the first user and a second user account associated with the second user is existent on the social network prior to the first user and the second user of the social network having attended the event;
responsive to determining that the connection being nonexistent between the first user account and the second user account on the social network prior to the first user and the second user having attended the event, facilitate a forming of the connection between the first user account and the second user account on the social network based on the first indication that the first user attended the event and the second indication that the second user attended the event;
generate an annotation corresponding to the formed connection between the first user account and the second user account on the social network based upon, at least in part, the first indication that the first user attended the event and the second indication that the second user attended the event, wherein the annotation identifies a context for the formed connection between the first user account and the second user account on the social network, the context identifying an origin of the formed connection by indicating that the first user and the second user first met at the event;
annotate the formed connection between the first user account and the second user account with the annotation on the social network;
determine the first user searching for the second user on the social network; and
provide for display the annotation in association with the second user account associated with the second user responsive to the first user searching for the second user.

21. The computing system of claim 20, wherein the one or more processors are further configured to:
create a social network connection group for the event, wherein the social network connection group includes at least the first user account and the second user account.

22. The computing system of claim 21, wherein facilitating the forming of the connection between the first user account and the second user account via the social network comprises:
checking the first user account into the event via the social network connection group based upon, at least in part, receiving the first indication that the first user attended the event; and
checking the second user account into the event via the social network connection group based upon, at least in part, receiving the second indication that the second user attended the event.

23. The computing system of claim 20, wherein facilitating the forming of the connection between the first user account and the second user account via the social network comprises:
adding the second user account to a social network connection candidate list for the first user account based upon, at least in part, the first indication that the first user attended the event and the second indication that the second user attended the event, wherein the social network connection candidate list indicates that the second user attended the event.

24. The computing system of claim 20, wherein facilitating the forming of the connection between the first user account and the second user account via the social network comprises:
sending an invitation to the second user account, wherein the invitation indicates to the second user that the first user is interested in connection of the first user account and the second user account, wherein the invitation is sent based upon, at least in part, receiving the first indication and the second indication.

25. A computer-implemented method comprising:
receiving, via one or more computing devices, a first indication that a first user of a social network attended an event and a second indication that a second user of the social network attended the event;
determining, via the one or more computing devices, whether a connection between a first user account associated with the first user and a second user account associated with the second user is existent on the social network prior to the first user and the second user of the social network having attended the event;
responsive to determining that the connection being existent between the first user account and the second user account on the social network prior to the first user and the second user having attended the event, generating, via the one or more computing devices, an annotation corresponding to the connection between the first user account and the second user account on the social network based upon, at least in part, the first indication that the first user attended the event and the second indication that the second user attended the event, wherein the annotation identifies a context for the connection between the first user account and the second user account, the context indicating that the first user and the second user met at the event; and
annotating, via the one or more computing devices, the connection between the first user account and the second user account with the annotation on the social network.
